(19) United States
(12) Patent Application Publication
(10) Pub. No.: US 2002/0080388 A1
(43) Pub. Date: Jun. 27, 2002

(54) Dynamic method for determining performance of network connected printing devices in a tandem configuration

(75) Inventors: Roy Kenneth Chrisop, Camas, WA (US); Thomas Daniel Davis JR., Camas, WA (US); Gary Lin Gaebel, Camas, WA (US)

Correspondence Address: Robert D. Varitz, ROBERT D. VARITZ, P.C., 380 Harrison Square, 1800 S.W. First Avenue, Portland, OR, 97201, US

(73) Assignee: Sharp Laboratories of America, Inc.

(21) Appl. No.: 09/749,997

(22) Filed: Dec. 27, 2000

(51) Int. Cl. G06F 15/00; B41B 1/00

(52) U.S. Cl. 358/1.15; 358/1.13

(57) ABSTRACT

A method of dynamic performance determination of network connected output devices, wherein each output device has a set of known characteristics, including entering a print job at a first network output device; querying other output devices on the network to determine each other output device's characteristics and pending print jobs to determine if a specific other output device is capable of performing the entered print job; transmitting a print job from the first network output device to each other capable output device; reporting the completion of a single copy of the entered print job by each other network output device; and determining the number of copies of the entered print job to be printed by the first network output device and each other output device.

### FIELD OF THE INVENTION

This invention relates to network printing, and specifically to the use of multiple networked hardcopy output devices, such as copiers and printers, to print copies of a job submitted to one of the output devices.

### BACKGROUND OF THE INVENTION

In a networked office environment, it is desirable to have multiple hardcopy output devices assist in completing the job, when making a large number of copies of a document. This typically is done by having the master device, i.e., the one where the operator started the job, query the other (slave) devices on the network to determine their availability and capabilities, and then dividing the number of copies to be done among the available devices, The problem for the master device lies in determining exactly how to divide the workload so as to complete the total job in the shortest possible time.

The general concept of querying supporting devices for capabilities and making a decision based on the answers received is well known in the prior art.

U.S. Pat. No. 5,978,560, for “Load balancing of distributed printing systems using enhanced printer attributes,” granted Nov. 2, 1999, to Tan et al., describes a system wherein a networked printer may be allocated an additional print job, depending on how many print jobs are already in its queue.

U.S. Pat. No. 5,940,186, “Multiple printer module electrophotographic printing device,” granted Aug. 17, 1999, and U.S. Pat. No. 5,596,416, for “Multiple printer module electrophotographic printing device,” issued Jan. 21, 1997, both to Barry et a., describe a method for distributing a print job to multiple printer engines, and a method to distribute images for printing to multiple printer modules using a image distributor to determine which image gets directed to which engine.

U.S. Pat. No. 5,859,711, for “Multiple print engine with virtual job routing,” granted Jan. 12, 1999, to Barry et al., describes a method to RIP print jobs into image data and then send the resulting page images to available print engines.

U.S. Pat. No. 5,784,077, for “Digital printing using plural cooperative modular printing devices,” granted Jul. 21, 1998, to Silverbrook, describes a system for duplex printing wherein each side is printed simultaneously.

U.S. Pat. No. 5,699,102, “Non-impact copier/printer system communicating rosterized [sic], printer independent data,” granted Dec. 16, 1997, to Ng et al., describes a method of transmitting print data to an engine for printing with an editing step. The distribution of the resulting print images to other printing devices over the network is also included, however, the reference does not address determining the printing characteristics/performance of the output devices to which the print jobs are distributed.

U.S. Pat. No. 5,467,434, for “Apparatus and method for determining printer option availability and representing conflict resolution in a combination of print job selections,” granted Nov. 14, 1995 to Hower, Jr. et al., describes a method for storing the characteristics of a group of network connected printer devices into profile structures. The profile structures are used by a print job manager to distribute incoming print jobs to the most suitable printer device, based on the characteristics of the print job.

U.S. Pat. No. 5,287,194, for “Distributed printing,” granted Feb. 15, 1994, to Lobiondo, describes the basic concept of allocating a print job among one or more printers, but does not address dynamic performance determination.

U.S. Pat. No. 5,179,673, for “Subroutine return prediction mechanism using ring buffers and comparing predicted address with actual address to validate or flush the pipeline,” granted Jan. 12, 1993 to Steely, Jr. et al., describes a stack technique for data transfer.

U.S. Pat. No. 4,125,874, for “Multiple printer control,” granted Nov. 14, 1978 to Higashide et al., describes a method wherein a central processing unit distributes print data to a group of network-connected printers.

However, none of the above-identified systems or methods describe a solution to the multiple output device problem as disclosed herein.

### SUMMARY OF THE INVENTION

A method of dynamic performance determination of network connected output devices, wherein each output device has a set of known characteristics, including entering a print job at a first network output device; querying other output devices on the network to determine each other output device's characteristics and pending print jobs to determine if a specific other output device is capable of performing the entered print job; transmitting a print job from the first network output device to each other capable output device; reporting the completion of a single copy of the entered print job by each other network output device; and determining the number of copies of the entered print job to be printed by the first network output device and each other output device.

It is an object of the invention to provide an output distribution method to allocate print jobs amongst plural output devices on a network according to the capabilities of each output device, referred to herein as dynamic performance determination.

This summary and objective of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 is a block diagram of the dynamic performance determination method of the invention.

### DETAILED DESCRIPTION OF THE PREFERRED EMBODIMENTS

As previously noted, a typical approach to solving the multiple output device problem is to have the master device, i.e., the device which originally receives the print job, whether it be a copier, a printer, or a multi-functional peripheral (NWP), query each available output device on the network, i.e., slave output device, for its pages per minute rating, then compute the number of copies to be done by each slave output device based on this information. Depending on the capabilities of each slave output device, this may or may not yield optimal results. The method of the invention more accurately assess the capabilities of the slave output devices and optimally dividing the number of copies to be made between the available slave output device.

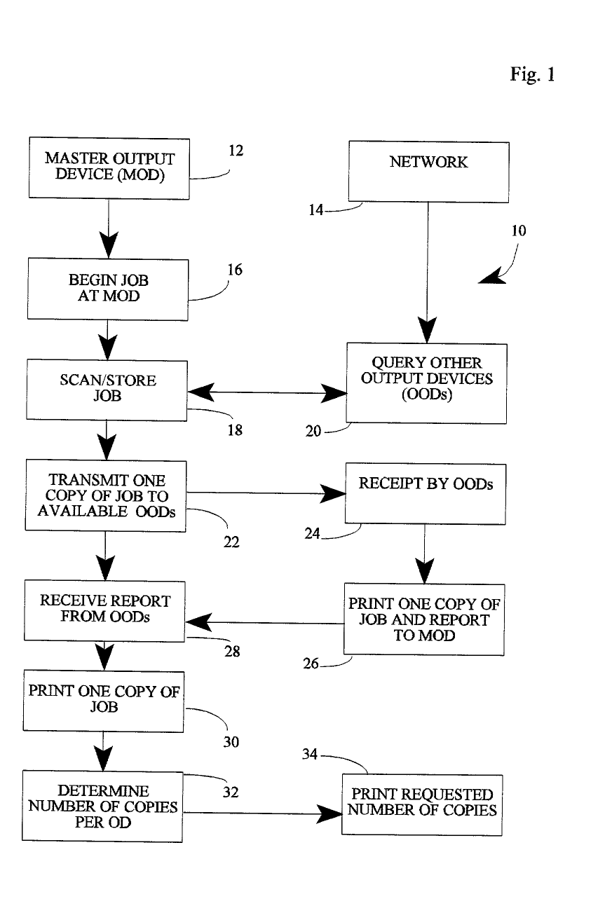

In a networked digital output device environment, the capability of the slave output devices to print pages from an incoming digital data stream is an important consideration. The method disclosed herein provides a way of assessing slave output devices printing speed and then optimally distributing the number of copies to be made among the available slave output devices, and is referred to herein as dynamic performance determination. The method of the invention, depicted generally at 10 in FIG. 1, is intended to work with a master output device (MOD) 12, which is connected to a communications network 14. A number of other output devices (OODs), also referred to herein as slave output devices, are connected to network 14 in a tandem configuration. The method includes the following steps:

1. The operator begins a multi-copy job at the master output device, block 16.

2. The master output device scans and digitally stores an image for each page of the print job, block 18. Blocks 16 and 18 are referred to herein as entering a print job.

3. The master output device queries the network for available output devices (ODs) with the required capabilities for the job, such as duplex, stapling, collating, etc, block 20. The capabilities of an OD define its characteristics. It should be noted that the collective term OD includes the MOD and all capable OODs.

4. The master output device transmits the data, block 22, for the job to each available slave output device, block 24, that is capable of printing the job, i.e., has the proper characteristics.

5. Each slave output device prints one copy of the job, block 26.

6. The slave output device may or may not be capable of storing the page image data and using it to print succeeding copies, and reports to master output device 12, block 28.

a. If the slave output device cannot store the page image data, it reports back to the master output device the total time from the start of data reception to completion of printing of the last page of the job. It also reports the fact that the data must be resent by the master for each copy to be printed, and that one copy has been printed so far.

b. If the slave output device can store the page image data, it prints a second copy to determine the time required to print one copy of the job from the internally storage page image data. It then reports back the time required to print the second copy, and that two copies have been printed so far.

The storage ability and the time to print further define the characteristics of each OD. It will also be appreciated that while certain characteristics, capability to duplex print, staple, etc., of an OD are known at the beginning of the operation, others, such as the capability to store the print job and the time to print, are changeable characteristics, and are determined during the print operation. The capability to store a print job may be present in an OD, however, the memory for such storage may be full as a result of other, lower priority print jobs, and therefor, not available for the specific print job under the control of the MOD.

7. The master output device prints one copy of the job itself, block 30, and records its time.

8. The master output device may use one of several methods for allocating the number of copies to be made among the available output devices. Such methods include:

a. The master output device may elect to wait until all slave output devices have reported their printing times before performing the calculation to optimize distribution of the number of copies among the slave output devices.

b. The master output device may elect to wait only a configurable amount of time, generally set by the system administrator, before dividing the copies to be made among the output devices that have reported back, and assumes that any output device which has yet to report is too slow to be of use.

c. When a large number of copies are to be made, which number exceeds a predetermined number set in the network, the master output device may elect to begin printing a small number of copies on each output device that has reported back, and defer the allocation calculation until all output devices have reported.

9. When the master output device determines the number of copies to be printed by each slave output device and by itself, block 32, it initiates the output process on the slave output devices, communicating the number of copies to be made to each slave, along with an indication that processing should begin, block 34.

Thus, a method for dynamic performance determination has been disclosed. It will be appreciated that further variations and modifications thereof may be made within the scope of the invention as defined in the appended claims.

We claim:

1. A method of dynamic performance determination of network connected output devices, wherein each output device has a set of characteristics, comprising:
entering a print job at a first network output device;
querying other output devices on the network to determine each other output device's characteristics and pending print jobs to determine if a specific other output device is capable of performing the entered print job;
transmitting a print job from the first network output device to each capable other output device;
reporting the completion of a single copy of the entered print job by each other output device; and
determining the number of copies of the entered print job to be printed by the first network output device and each other output device.

2. The method of claim 1 wherein said determining includes determining the number of copies of the entered print job to be printed by the first network output device and each other output device by optimizing the number of copies to be printed by all output devices after all of the other output devices have reported to the first output device.

3. The method of claim 1 wherein said determining includes determining the number of copies of the entered print job to be printed by the first network output device and each other output device by optimizing the number of copies to be printed by all output devices after a predetermined amount of time has passed from said transmitting, and wherein the number of copies to be printed is allocated only among the first output device and such other output devices which have reported the completion of printing the first copy of the entered print job.

4. The method of claim wherein the number of copies to be printed exceeds a predetermined number, and wherein the first network output device initiates printing on itself and each of the other output devices as other output devices report completion of their first copy of the entered print job, and wherein the first network output device makes a final determination of the number of copies which each output device is to print after all of the other output devices have reported.

5. The method of claim 1 wherein said entering includes loading a print job into the first network output device and storing the print job in the first network output device.

6. The method of claim 1 wherein said determining is performed by the first network output device.

7. A method of dynamic performance determination of network connected output devices, wherein each output device has a set of characteristics, comprising:
entering a print job at a first network output device, including loading a print job into the first network output device and storing the print job in the first network output device;
querying other output devices on the network to determine each other output device's characteristics and pending print jobs to determine if a specific other output device is capable of performing the entered print job;
transmitting a print job from the first network output device to each capable other output device,
reporting the completion of a single copy of the entered print job by each other output device; and
determining, by the first network output device, number of copies of the entered print job to be printed by the first network output device and each other output device.

8. The method of claim 7 wherein said determining includes determining the number of copies of the entered print job to be printed by the first network output device and each other output device by optimizing the number of copies to be printed by all output devices after all of the other output devices have reported to the first output device.

9. The method of claim 7 wherein said determining includes determining the number of copies of the entered print job to be printed by the first network output device and each other output device by optimizing the number of copies to be printed by all output devices after a predetermined amount of time has passed from said transmitting, and wherein the number of copies to be printed is allocated only among the first output device and such other output devices which have reported the completion of printing the first copy of the entered print job.

10. The method of claim 7 wherein the number of copies to be printed exceeds a predetermined number, and wherein the first network output device initiates printing on itself and each of the other output devices as other output devices report completion of their first copy of the entered print job, and wherein the first network output device makes a final determination of the number of copies which each output device is to print after all of the other output devices have reported.
